(19) United States
(12) Patent Application Publication
(10) Pub. No.: US 2010/0103379 A1
(43) Pub. Date: Apr. 29, 2010

(54) METHOD FOR GENERATING AN IMAGE AND A PROJECTOR AND A CELL PHONE HAVING A PROJECTOR

(76) Inventor: Reinhold Fiess, Durbach (DE)

Correspondence Address: KENYON & KENYON LLP, ONE BROADWAY, NEW YORK, NY, 10004, US

(21) Appl. No.: 12/561,659

(22) Filed: Sep. 17, 2009

(30) Foreign Application Priority Data
Oct. 24, 2008 (DE) 102008043153.2

(51) Int. Cl. G03B 21/14; G02B 27/22

(52) U.S. Cl. 353/7; 353/121; 353/30

(57) ABSTRACT

A method for generating an image from at least two partial images, each partial image being generated with the aid of a projector. The projectors communicate with each other via a wireless connection for aligning the partial images. A projector and a cell phone having at least one projector.

### CROSS REFERENCE

The present application claims the benefit under 35 U.S.C. §119 of German Patent Application No. 102008043153.2 filed on Oct. 24, 2008, the entirety of which is expressly incorporated herein by reference.

### FIELD OF THE INVENTION

The present invention relates to a method for generating an image from at least two partial images, each partial image being generated with the aid of a projector. The present invention furthermore relates to a projector and to a cell phone having a projector.

### BACKGROUND INFORMATION

Conventional projectors for large-scale projections may generate two partial images having different polarizing directions. The user wears a pair of polarizing spectacles having two crossed pole filters, so that each eye sees a different image. This enables stereoscopic viewing. These projectors are typically connected to a control unit via a cable and the control unit transmits the image content to be projected to the projectors via the cable-bound connections. The projectors used are stationary, i.e., they are not portable or portable only with difficulty. In addition, at least two projectors and the control unit for the projectors must be carried. This presents great limitations for many applications in which easy transportation, quick initial operation, and easy adjustment are desirable. Moreover, a cell phone having a laser projection device for projecting information on a projection surface is described in German Patent Application No. DE 101 02 463 A1.

### SUMMARY

An example method for generating an image from at least two partial images according to the present invention may have the advantage over the related art in that easy transportation, easy initial operation, and adjustment of the projectors are made possible. According to the example embodiment of the present invention, this is achieved in that the projectors communicate with one another via a data link for aligning the partial images. There is, thus, an automated coupling of multiple projectors in order to generate an image from the partial images. For example, by using multiple projectors, the generatable image area may be enlarged by positioning the partial images so that they adjoin each other. The partial images are aligned, for example, via a wireless connection via which the projectors communicate with one another. It may be provided that it is automatically established which projector generates which partial image. For example, the complete image to be projected may be available to all projectors, the projectors exchanging information about the partition of the image into partial images via the data link. A control unit which activates the projectors is thus not needed since it is already contained in the projectors. It is particularly advantageous here if the projectors may be situated arbitrarily but may align the partial images with the aid of the wireless connection, so that the image may be displayed. Moreover, it is also possible that the projected images of the multiple projectors are superimposed in order to achieve higher image brightness.

It is advantageous if the image is generated as a stereo image. In this case, at least two partial images are superimposed, thereby generating a stereo image. For example, the beam sources of the projectors may be linearly polarized and angled toward one another, corresponding to the polarization planes of a pair of polarizing spectacles which an observer wears.

A refinement of the present invention provides that a camera is assigned to the projector which is used for aligning the partial images. The image generated by the projector or the projectors from the at least two partial images may be recorded and analyzed with the aid of the camera. In this way, the partial images may be aligned with the aid of the camera. This allows automated alignment and location-dependent assembly of the partial images with the aid of the camera as a measuring unit. In this way, the edges of the partial images may be analyzed with the aid of the camera during generation of the image from the at least two partial images, for example. If deviations occur, the projector may compensate for them so that the partial images are adjusted to one another and their position is aligned, so that the images are situated on top of each other or are adjacent to one another.

One refinement of the present invention provides that the projector is integrated into a cell phone or into a PDA. In this way, the projector may use the hardware and software present in the cell phone or the PDA for generating the image. For example, many of today's cell phones already contain a camera, so there is no need to provide additional elements. Moreover, the processor has sufficient computing power in most cell phones/PDAs, so that the partial images may be processed without any problems. The projector is thus designed to be so small that it may be integrated into the cell phone or the PDA without difficulty. In this way, the projector is extremely portable and may always be carried along.

One refinement of the present invention provides that the cell phone or the PDA has the camera. Many cell phones or PDAs meanwhile have an installed camera. The achieved activations are sufficient to record and to analyze the image or the partial images for aligning the partial images.

One refinement of the present invention provides that the projectors use linearly polarized beam sources and are laser projectors in particular. Due to the linearly polarized beam sources, it is easily possible to angle the polarization planes of the individual projectors toward one another. For this purpose, the projector must simply be rotated, for example by 90°. If laser projectors are used, there is the considerable advantage that an extremely high depth of field of the projection may be achieved. The distance between the projectors and to a projection surface may thus vary considerably. The laser projectors may carry out a monochrome presentation; however, it may also be provided that multiple lasers having different wavelengths are provided in the laser projector.

One refinement of the present invention provides that a Bluetooth connection, a WLAN connection, and/or a GSM connection is used as the wireless connection. In principle, any wireless connection between the projectors is usable. However, Bluetooth, WLAN and/or GSM connections are preferably used since these are frequently provided in cell phones or PDAs. Additional elements have to be provided only when the projector is not to be used in connection with such a device. If a cell phone having an integrated camera is used, an automated alignment and a location-dependent assembly of the partial images with the aid of the installed camera as a measuring unit and the wireless connection between the at least two cell phones may be implemented. In this case, the

Bluetooth connection, the WLAN connection and/or the GSM connection is used depending on how the cell phone is equipped. Two or more users may very easily couple their cell phones to laser projectors and view three-dimensional image contents, e.g., images or games, with the aid of polarizing spectacles. The correct positioning of the partial images for the stereoscopic image impression is achieved by aligning the partial images through the communication of the cell phones. The option “stereo viewing” may thus relatively easily be implemented and marketed as an accessory to cell phones having laser projectors.

One refinement of the present invention provides that image information and/or image contents are exchanged via the data link. Image information may be, for example, the size of the image, the partition of the image into partial images, the size of the individual partial images and their position to each other, the actual position of the partial images to each other, and the mode in which the image is to be generated from the partial images. The mode thus describes whether a stereoscopic image is to be generated by overlapping at least two partial images or a large image assembled from multiple partial images is to be generated. Likewise, image contents may be exchanged between the projectors via the wireless connection. For example, the image may be present on only one of the projectors which, as a function of the image information, distributes individual partial images to other projectors, for example. However, it may also be provided that the image is present on all projectors simultaneously and these exchange only that image information among each other with the help of which it is then established how the image is to be broken up into partial images. Each projector thus has the complete image but projects only the respective partial image based on the image information exchanged via the wireless connection.

One refinement of the present invention provides that the partial images are aligned by projecting a test pattern with the aid of the projector and recording it using the camera. The projectors are automatically aligned to each other by projecting the test pattern in a certain angular range. The projection surface is recorded via the camera and analyzed via appropriate image processing software. At the same time, the projectors may communicate with each other via the data link in order to exchange the images or image contents recorded by the camera. In this way, according to the mode, i.e., stereoscopic image or lining up the partial images to form one large image, the partial images may be aligned. After the partial images are aligned with the test pattern, the image may now be generated from the at least two partial images.

In a first specific embodiment, the test pattern may be aligned automatically with the aid of an analysis via the camera and adapted to an image position. In a further specific embodiment, a position of the test pattern may be changed either by changing the position in space of at least one projector or by a user changing manually via an operating unit on the projector in order to create an overlap of the test patterns and thus the adaptation of the projections of the multiple projectors.

One refinement of the present invention provides that multiple projectors are situated offset to one another. The projectors may thus be situated arbitrarily, i.e., they may have different distances to a projection surface, for example, or may be situated at different angles to the projection surface. Deviations of this type are compensated using the alignment of the partial images via the wireless connection, so that the image may be generated from the at least two partial images.

Moreover, the present invention relates to a projector, in particular for applying the method described above, which generates a partial image of an image. It is provided here that the partial image is aligned with the aid of a data link to at least one additional projector. The camera may be provided on the projector or may be assigned to it. Of course, the projector may be refined according to the preceding descriptions.

Furthermore, the present invention relates to a cell phone having at least one projector, in particular as recited in the preceding descriptions and/or for applying the method as recited in the preceding description. The cell phone may thus also have more than one projector. These may have different polarization directions, for example, so that a stereoscopic image may be generated by a single cell phone.

### BRIEF DESCRIPTION OF THE DRAWINGS

The present invention is explained in greater detail below based on the exemplary embodiments illustrated in the figures without restricting the present invention.

FIG. 1 shows a schematic representation of a projector which is designed as a laser projector.

FIG. 2 shows a schematic representation of a cell phone having the laser projector, a camera, and a wireless interface.

FIG. 3 shows a schematic representation in which an interconnection of two cell phones for generating an image from two partial images is illustrated.

### DETAILED DESCRIPTION OF EXAMPLE EMBODIMENTS

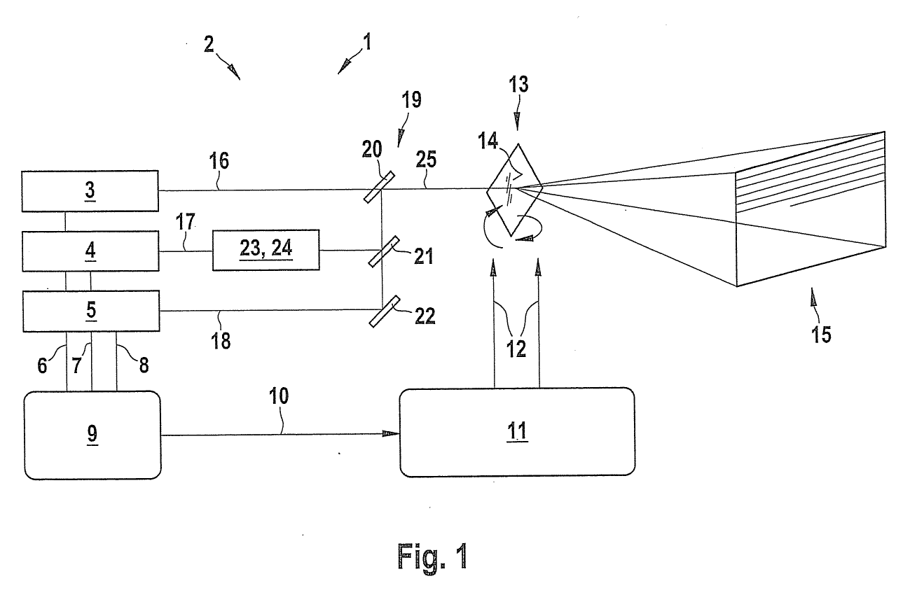

FIG. 1 shows a schematic representation of a projector 1 which is designed as a laser projector 2. Laser projector 2 has a first laser 3, a second laser 4, and a third laser 5. First laser 3 generates a laser beam in the red wavelength range, second laser 4 in the infrared wavelength range, and third laser 5 in the blue wavelength range. Correspondingly, lasers 3, 4, and 5 are addressed via a first signal line 6, a second signal line 7, and a third signal line 8 which together transmit an RGB signal. Signal lines 6, 7, and 8 are connected to a video controller 9 which activates lasers 3, 4, and 5 via signal lines 6, 7, and 8. Via a further signal line 10, video controller 9 activates a scan-controller 11 which activates a biaxial scanner unit 13 via links 12. When triggered by scan-controller 11, the biaxial scanner unit may be rotated about two axes. Scanner unit 13 has a reflecting surface 14 via which incident light of lasers 3, 4, and 5 may be projected in an image plane 15. Lasers 3, 4, and 5 generate laser beams 16, 17, and 18. First laser beam 16 and third laser beam 18 directly strike a mirror system 19 which is composed of three mirrors 20, 21, and 22. Second laser beam 17 initially runs through a frequency converter 23, which is present in the form of an NLO (non-linear optics) crystal 24 and in which the frequency range of the second laser is shifted from the infrared range into the visible range. Second laser beam 17 subsequently strikes second mirror 21. First mirror 20 as well as second mirror 21 are designed as semi-transparent mirrors. This means that they not only reflect light striking their surface, but also let light pass through, at least partially. Third mirror 22 is not transparent; it thus reflects laser beam 18 completely. In this way, mirror system 19 transforms laser beams 16, 17, and 18 into one laser beam 25 which thus has the wavelengths of all three lasers 3, 4, and 5. Laser beam 25 produced in this way runs through scanner unit 13 where it strikes reflecting surface 14 and is deflected according to its position and strikes image plane 15 at a certain point. In this way, projector 1 may generate an image or a partial image in image plane 15.

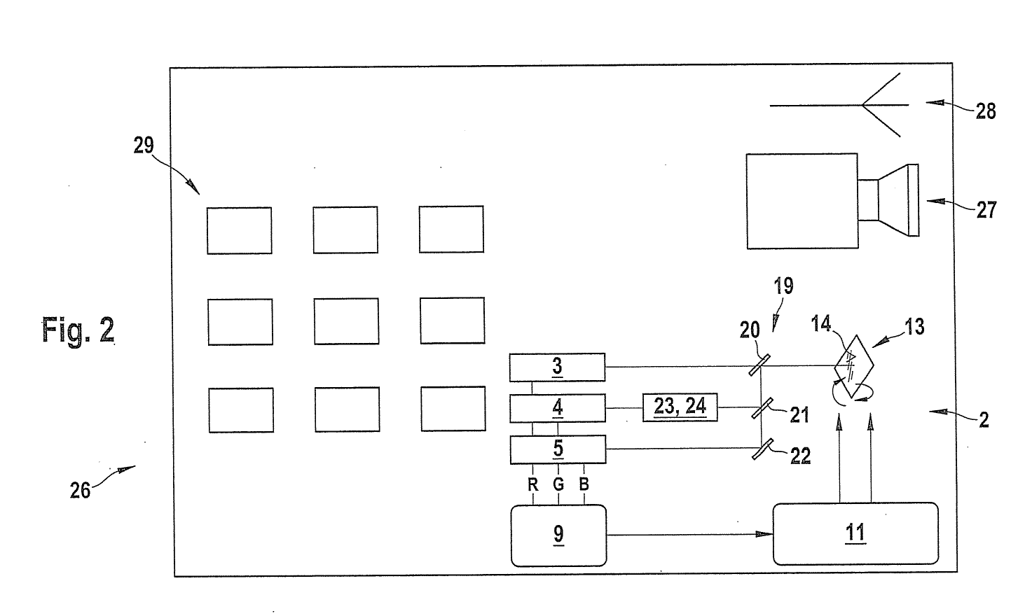

FIG. 2 shows a schematic representation of a cell phone 26, having laser projector 2, a camera 27, and a wireless module 28. In addition, cell phone 26 is equipped with operating elements 29 and a screen (not shown). With the aid of wireless module 28, cell phone 26 may establish a Bluetooth connection, a WLAN connection, and/or a GSM connection, for example.

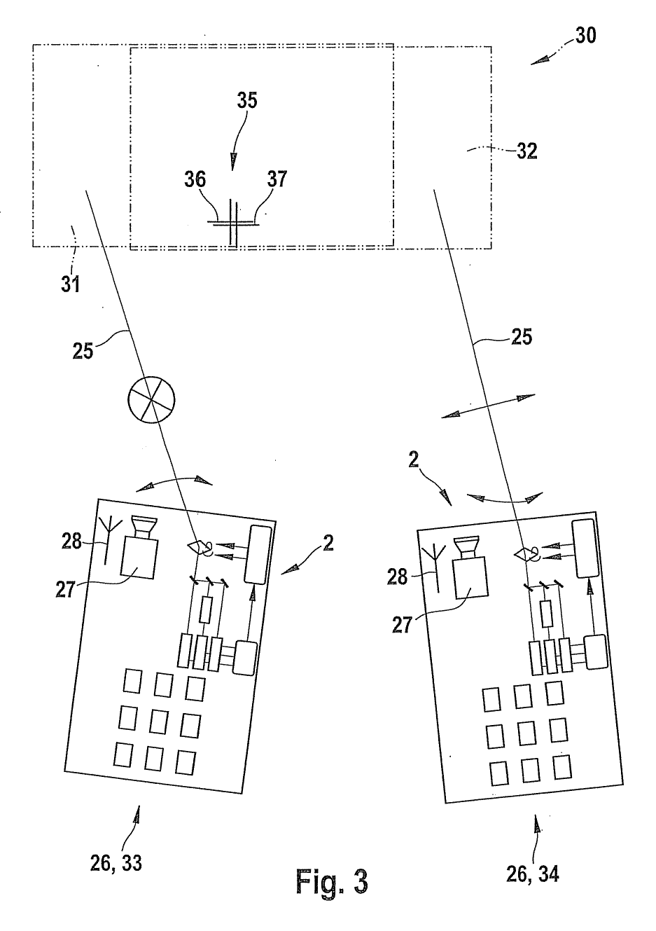

FIG. 3 shows a schematic representation in which two cell phones 26 are used to generate an image 30 from a first partial image 31 and a second partial image 32. In this case, a first cell phone 33 generates first partial image 31 and a second cell phone 34 generates second partial image 32. Both cell phones 26 are configured in such a way as is apparent in FIG. 2. They merely differ in a polarization direction of laser projector 2. While laser beam 25 of first cell phone 33 is polarized perpendicular to the image plane, laser beam 25 of second cell phone 34 is polarized parallel to the image plane. In this way, a stereoscopic image 30 may be generated which a viewer may see through a pair of polarizing spectacles. In order to align partial images 31 and 32 toward each other, cell phones 26 generate a test pattern 35, first cell phone 33 projecting a first marking 36 and second cell phone 34 projecting a second marking 37. With the aid of camera 27, cell phones 26 record and analyze test pattern 35. If this analysis shows that first marking 36 and second marking 37 are not ideally aligned to each other, partial images 31 and 32 are adjusted via a wireless connection which is established with the aid of wireless module 28. During adjustment or alignment of partial images 31 and 32, first cell phone 33 and/or second cell phone 34 change(s) a position of partial image 31/32 projected thereby. In this way, partial images 31 and 32 may be exactly aligned so that image 30 may be generated from partial images 31 and 32.

In one further specific embodiment, both cell phones may be aligned with respect to the polarization direction of their laser projector in the same way or they may have an undefined alignment to each other. Hereby, it is possible to assemble the individual projected images of the two projectors into a large single image in order to obtain a larger projection surface. It is furthermore also possible to project both images on top of each other in order to obtain a brighter image display.

Furthermore, in one specific embodiment the cell phones have an operating unit, e.g., a key pad, using which the size of a displayed test pattern of a first cell phone may be adapted to the size of a similar test pattern displayed by the second cell phone. It is thus possible, for example, to change the size of displayed cross hairs and/or the position of displayed cross hairs via the key pad. Via the manual input, a projection of the one projector is adapted to the projection of the at least one other projector after a successful adaptation of the test pattern with respect to location and size. Due to this adjustment, an image projection of the multiple projectors adapted to one another may now take place.

What is claimed is:

1. A method for generating an image from at least two partial images, comprising:
generating each partial image with the aid of a respective projector; and
communicating, by the projectors with each other via a wireless connection, for aligning the partial images.

2. The method as recited in claim 1, wherein the image is generated as a stereo image.

3. The method as recited in claim 1, further comprising:
assigning a camera to the projector, the camera being used for aligning the partial images.

4. The method as recited in claim 1, wherein the projector is integrated into a cell phone or into a PDA.

5. The method as recited in claim 1, further comprising:
projecting, by one of the projectors, a test pattern, the test pattern being used to align projections from the projectors.

6. The method as recited in claim 5, further comprising:
changing, via a manual input, the projected test pattern.

7. The method as recited in claim 6, wherein both of the projectors project a test pattern, and the changing manually adapts the test pattern.

8. The method as recited in claim 1, wherein each projector is a laser projector, and each projector generates one of the partial images via a lineraly polarized beam source.

9. The method as recited in claim 1, wherein at least one of image information and image contents are exchanged via the wireless connection.

10. The method as recited in claim 3, wherein the partial images are aligned by projecting a test pattern with the aid of the projector and recording the projected test pattern using the camera.

11. The method as recited in claim 1, wherein multiple projectors are situated offset to one another.

12. A projector, comprising:
an interface to establish a data link to another projector and to transmit control data to the other projector in such a way that partial images projected by the projectors at least partially overlap, and an image to be displayed is composed of the partial images projected by the two projectors.

13. The projector as recited in claim 12, further comprising:
a generating device to generate a test pattern for aligning a position of a test pattern with a test pattern projected by the other projector.

14. The projector as recited in claim 13, further comprising:
an operating unit to adjust a size of the test pattern for adapting to a size of the test pattern projected by the other projection device.

15. The projector as recited in claim 12, wherein the data link is a wireless interface.

16. A portable electronic device, comprising:
a cell phone; and
a projector integrated into the cell phone, the projector including an interface to establish a data link to another projector and to transmit control data to the other projector in such a way that partial images projected by the projectors at least partially overlap, and an image to be displayed is composed of the partial images projected by the two projectors.

17. The portable electronic device according to claim 16, further comprising:
a camera, integrated into the cell phone, the camera adapted to record a partial image projected by the other projector for adapting the partial image projected by the other projector.
